(19) United States
(12) Patent Application Publication
(10) Pub. No.: US 2026/0031401 A1
(43) Pub. Date: Jan. 29, 2026

(54) ELECTROLYTES COMPRISING ALKYL ALKANOATES, KETONES, AND/OR NITRILES AS PRIMARY ORGANIC SOLVENTS FOR BATTERIES THAT CYCLE LITHIUM IONS

(71) Applicant: GM GOBAL TECHNOLOGY OPERATIONSA LLC, Detroit, MI (US)

(72) Inventors: Yan WU, Xuancheng (CN); Jingyuan Liu, Shanghai (CN); Dewen Kong, Shanghai (CN); Haijing Liu, Shanghai (CN)

(21) Appl. No.: 18/890,850

(22) Filed: Sep. 20, 2024

(30) Foreign Application Priority Data
Jul. 26, 2024 (CN) 2024110175504

(51) Int. Cl. H01M 10/0569; H01M 4/02; H01M 4/525; H01M 10/0525; H01M 10/0567; H01M 10/0568

(52) U.S. Cl. CPC H01M 10/0569; H01M 4/525; H01M 10/0525; H01M 10/0567; H01M 10/0568; H01M 2004/028; H01M 2220/20; H01M 2300/0034; H01M 2300/0037

(57) ABSTRACT

A battery that cycles lithium ions includes an electrolyte including an organic solvent and a lithium salt in the organic solvent. The organic solvent includes greater than or equal to 70 weight percent of a primary solvent including an alkyl alkanoate, ketone, nitrile, or a combination thereof. The electrolyte beneficially may be used in a battery that includes a positive electrode including an electroactive material including a layered nickel-rich lithium transitional metal oxide.

### CROSS-REFERENCE TO RELATED APPLICATIONS

This application claims the benefit of Chinese Patent Application No. 202411017550.4, filed on Jul. 26, 2024. The entire disclosure of the application referenced above is incorporated herein by reference.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to electrolytes for batteries that cycle lithium ions, and more particularly to organic solvents for electrolytes of batteries that include layered nickel-rich lithium transitional metal oxides as electroactive positive electrode materials.

Batteries that cycle lithium ions generally include a positive electrode, a negative electrode spaced apart from the positive electrode, and an ionically conductive electrolyte that provides a medium for the conduction of lithium ions between the positive and negative electrodes during discharge and charge of the batteries. The electrolyte may be formulated to exhibit certain desirable properties including high ionic conductivity, high dielectric constant (correlated with a high ability to dissolve salts), good thermal stability, a wide electrochemical stability window, ability to form a stable ionically conductive solid electrolyte interphase on the surface of the positive electrode and/or the negative electrode, and chemical compatibility with other components of the batteries.

### SUMMARY

A battery that cycles lithium ions, in accordance with one or more embodiments of the present disclosure, comprises a positive electrode and an electrolyte infiltrating the positive electrode. The positive electrode comprises an electroactive material comprising a layered nickel-rich lithium transitional metal oxide. The electrolyte comprises an organic solvent and a lithium salt in the organic solvent. The organic solvent comprises greater than or equal to 70 weight percent of a primary solvent comprising an alkyl alkanoate, ketone, nitrile, or a combination thereof.

The primary solvent may comprise an alkyl alkanoate having the formula R¹—COO—R², where R¹ is H, a C₁-C₃ alkyl, or a C₁-C₃ fluoroalkyl, and where R² is a C₁-C₄ alkyl or a C₁-C₄ fluoroalkyl.

The primary solvent may comprise at least one alkyl alkanoate selected from the group consisting of 2,2,2-trifluoroethyl acetate (FEA), ethyl acetate (EA), n-propyl acetate (nPA), i-propyl acetate (iPA), n-butyl acetate (nBA), i-butyl acetate (iBA), methyl propionate (MP), methyl butyrate (MB), methyl formate (MF), ethyl formate (EF), n-propyl formate (nPF), i-propyl formate (iPF), n-butyl formate (nBF), and i-butyl formate (iBF).

The primary solvent may comprise a ketone having the formula R³—C(═O)—R⁴, where R³ and R⁴ are each individually a C₁-C₂ alkyl or a C₁-C₂ fluoroalkyl.

The primary solvent may comprise at least one ketone selected from the group consisting of acetone and 2-butanone.

The primary solvent may comprise a nitrile having the formula R⁵—C═N, where R⁵ is a C₁-C₃ alkyl or a C₁-C₃ fluoroalkyl.

The primary solvent may comprise at least one nitrile selected from the group consisting of acetonitrile (ACN), propionitrile (PN), n-butyronitrile (nBN), and i-butyronitrile (iBN).

The organic solvent may comprise greater than 0 weight percent and less than 30 weight percent of at least one linear organic carbonate selected from the group consisting of dimethyl carbonate (DMC), ethyl methyl carbonate (EMC), and diethyl carbonate (DEC).

The organic solvent may comprise greater than 0 weight percent and less than 15 weight percent of at least one cyclic organic carbonate selected from the group consisting of ethylene carbonate (EC), propylene carbonate (PC), and fluoroethylene carbonate (FEC).

The electrolyte may be substantially free of cyclic organic carbonates. The electrolyte may comprise greater than or equal to 0.5 Molar and less than or equal to 4 Molar of at least one lithium salt selected from the group consisting of lithium hexafluorophosphate (LiPF₆), lithium bis(fluorosulfonyl)imide (LiFSI), lithium bis(trifluoromethanesulfonyl)imide (LiTFSI), lithium tetrafluoroborate (LiBF₄), lithium bis(oxalato)borate (LiBOB), and lithium difluoro(oxalato)borate (LiDFOB).

The electrolyte may comprise greater than or equal to 0.6 Molar and less than or equal to 1 Molar of a primary lithium salt consisting of LiPF₆. The electrolyte may comprise greater than or equal to 0.2 Molar and less than or equal to 0.6 Molar of at least one secondary lithium salt selected from the group consisting of LiFSI and LiTFSI.

The electrolyte may further comprise greater than 0 weight percent and less than or equal to 10 weight percent of at least one additive selected from the group consisting of succinic anhydride (SA), trimethoxymethylsilane (TMSi), and tris(trimethylsilyl) phosphite (TMSPi).

The electroactive material of the positive electrode may comprise a layered nickel-rich lithium transition metal oxide represented by the formula LiNi₁₋ₓMeₓO₂, wherein 0≤x<0.4, where Me comprises manganese (Mn), cobalt (Co), aluminum (Al), or a combination thereof.

A battery that cycles lithium ions, in accordance with one or more embodiments of the present disclosure, comprises a negative electrode, a positive electrode spaced apart from the negative electrode, and an electrolyte infiltrating the negative electrode and the positive electrode. The negative electrode comprises an electroactive negative electrode material comprising silicon, silicon oxide, lithiated silicon oxide, and/or graphite. The positive electrode comprises an electroactive positive electrode material comprising a layered nickel-rich lithium transition metal oxide represented by the formula LiNi₁₋ₓMeₓO₂, where 0≤x<0.4, and where Me comprises manganese (Mn), cobalt (Co), aluminum (Al), or a combination thereof. The electrolyte provides a medium for the conduction of lithium ions between the negative electrode and the positive electrode. The electrolyte comprises greater than or equal to 60 weight percent and less than or equal to 93 weight percent of an organic solvent and a lithium salt in the organic solvent. The organic solvent comprises greater than or equal to 70 weight percent of a primary solvent comprising at least one of: an alkyl alkanoate having the formula R¹—COO—R², where R¹ is H, a C₁-C₃ alkyl, or a C₁-C₃ fluoroalkyl, and where R² is a C₁-C₄ alkyl or a C₁-C₄ fluoroalkyl; a ketone having the formula R³—C(═O)—R⁴, where R³ and R⁴ are each individually a C₁-C₂ alkyl or a C₁-C₂ fluoroalkyl; or a nitrile having the formula R⁵—C≡N, where R⁵ is a C₁-C₃ alkyl or a C₁-C₃ fluoroalkyl.

The primary solvent may comprise at least one alkyl alkanoate selected from the group consisting of 2,2,2-trifluoroethyl acetate (FEA), ethyl acetate (EA), n-propyl acetate (nPA), i-propyl acetate (iPA), n-butyl acetate (nBA), i-butyl acetate (iBA), methyl propionate (MP), methyl butyrate (MB), methyl formate (MF), ethyl formate (EF), n-propyl formate (nPF), i-propyl formate (iPF), n-butyl formate (nBF), and i-butyl formate (iBF).

The primary solvent may consist of 2,2,2-trifluoroethyl acetate (FEA).

The primary solvent may comprise at least one ketone selected from the group consisting of acetone and 2-butanone.

The primary solvent may comprise at least one nitrile selected from the group consisting of acetonitrile (ACN), propionitrile (PN), n-butyronitrile (nBN), and i-butyronitrile (iBN).

The organic solvent may comprise greater than 0 weight percent and less than 30 weight percent of at least one linear organic carbonate selected from the group consisting of dimethyl carbonate (DMC), ethyl methyl carbonate (EMC), and diethyl carbonate (DEC). The organic solvent may comprise greater than 0 weight percent and less than 15 weight percent of at least one cyclic organic carbonate selected from the group consisting of ethylene carbonate (EC), propylene carbonate (PC), and fluoroethylene carbonate (FEC).

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a schematic perspective view of an automotive vehicle powered by a battery pack that includes multiple battery modules.

FIG. 2 is a schematic cross-sectional view of a portion of one of the battery modules of FIG. 1, the battery module including multiple electrochemical cells or batteries that cycle lithium ions.

FIG. 3 is a schematic cross-sectional view of a battery that cycles lithium ions, the battery comprising a positive electrode, a negative electrode, a porous separator, and an electrolyte infiltrating the positive and negative electrodes and the porous separator.

FIG. 4 is a plot of Intensity (arbitrary units) vs. 2θ (degree) depicting XRD spectra of a layered nickel-rich transition metal oxide during heating from ambient temperature to about 430° C.

FIG. 5 is a plot of Voltage (V) vs. Specific Capacity (mAh/g) depicting the charge and discharge curves during formation of a battery including an electrolyte in accordance with one or more embodiments of the present disclosure.

FIG. 6 is a plot of Voltage (V) vs. Specific Capacity (mAh/g) depicting the charge and discharge curves of a battery charged and discharged at a C/3 rate and including an electrolyte in accordance with one or more embodiments of the present disclosure.

FIG. 7 is a plot of Discharge Capacity Retention (%) vs. Cycle Number for a battery discharged at different rates and including an electrolyte in accordance with one or more embodiments of the present disclosure.

FIG. 8 is a plot of Capacity Retention (%) vs. Cycle Number for a battery charged at different rates and including an electrolyte in accordance with one or more embodiments of the present disclosure.

FIG. 9 is a plot of Heat Flow (W/g) vs. Temperature (° C.) for positive electrodes comprising layered nickel-rich transition metal oxides as electroactive materials in the absence and presence of different electrolyte formulations.

In the drawings, reference numbers may be reused to identify similar and/or identical elements.

### DETAILED DESCRIPTION

The presently disclosed electrolytes are formulated for use in batteries that cycle lithium ions and comprise an alkyl alkanoate, ketone, and/or nitrile as the primary organic solvent therein. The primary organic solvent in the presently disclosed electrolytes is formulated to eliminate or reduce the need for the inclusion of cyclic organic carbonates (e.g., ethylene carbonate, EC) and/or linear organic carbonates in the electrolytes, which is oftentimes included in electrolytes of batteries that cycle lithium ions to provide the electrolytes with high ionic conductivity (i.e., high dielectric constant and low viscosity).

Use of the presently disclosed electrolytes may be particularly beneficial in batteries that include layered nickel-rich lithium transitional metal oxides (Ni-rich oxides) as electroactive positive electrode materials. Without intending to be bound by theory, it is believed that, when Ni-rich oxides are used as electroactive positive electrode materials in batteries that cycle lithium ions, the Ni-rich oxides may decompose at high temperatures (e.g., at temperatures greater than or equal to about 210 degrees Celsius, ° C.) and generate oxygen (O) radicals within the batteries. If such batteries include cyclic organic carbonate-containing electrolytes, the oxygen radicals generated by thermal decomposition of the Ni-rich oxides may react exothermically with the cyclic organic carbonates, resulting in the undesirable generation of heat. The presently disclosed electrolytes have high ionic conductivity without the inclusion of cyclic organic carbonates and/or linear organic carbonates, and thus can be used in batteries that cycle lithium ions to help reduce or eliminate the need for the inclusion of cyclic organic carbonates in the electrolytes, and thereby improve the thermal stability thereof.

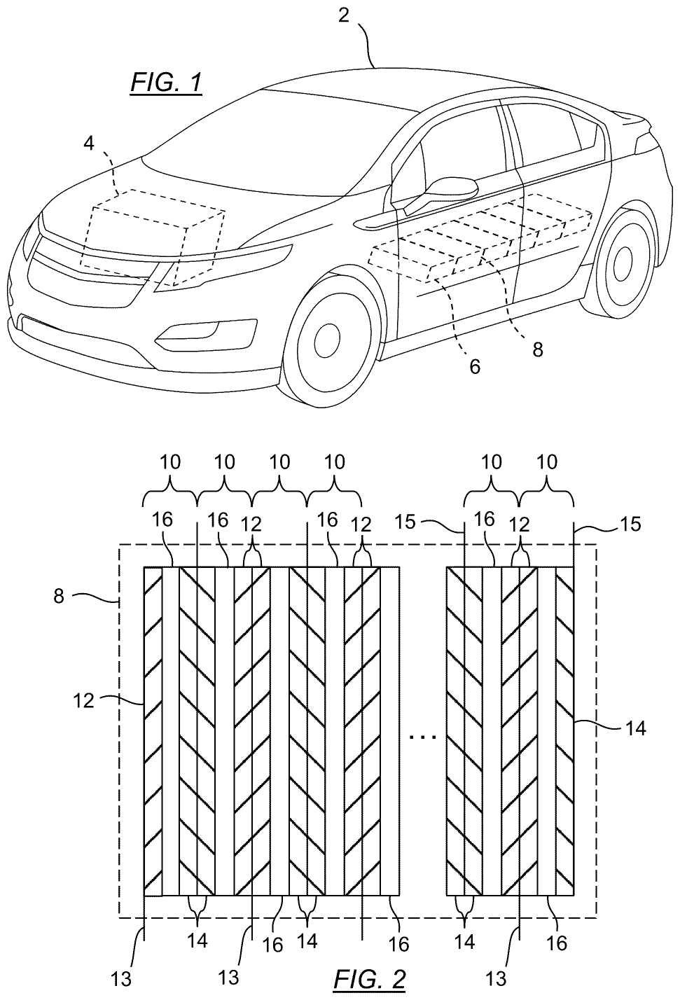

FIG. 1 depicts an automotive vehicle 2 powered by an electric motor 4 that draws electricity from a battery pack 6 including one or more battery modules 8. The battery modules 8 may be electrically coupled together in a series and/or parallel arrangement to meet desired capacity and power requirements of the electric motor 4. The vehicle 2 may be an all-electric vehicle and may be powered exclusively by the electric motor 4, or the vehicle 2 may be a hybrid electric vehicle and may be powered by the electric motor 4 and by an internal combustion engine (not shown).

As shown in FIG. 2, each battery module 8 includes one or more electrochemical cells or batteries 10 that cycle lithium ions. In practice, the batteries 10 in the battery module 8 are oftentimes assembled as a stack of layers, including negative electrode layers 12, negative electrode current collectors 13, positive electrode layers 14, positive electrode current collectors 15, and separator layers 16. Each battery 10 is defined by a negative electrode layer 12 and a positive electrode layer 14, which are spaced apart from each other by a separator layer 16. In practice, the separator layer 16 may be infiltrated with an electrolyte that provides a medium for the conduction of lithium ions between the negative electrode layer 12 and the positive electrode layer 14, or the separator layer 16 itself may function as an electrolyte. The negative electrode layers 12 are disposed on and in electrical communication with the negative electrode current collectors 13 and the positive electrode layers 14 are disposed on an in electrical communication with the positive electrode current collectors 15. As shown in FIG. 2, for efficiency, the layers may be stacked such that some of the negative electrode current collectors 13 and some of the positive electrode current collectors 15 are double sided and respectively include negative electrode layers 12 or positive electrode layers 14 on both sides thereof. In this arrangement, adjacent negative electrode layers 12 and positive electrode layers 14 respectively share a single negative electrode current collector 13 or a positive electrode current collector 15.

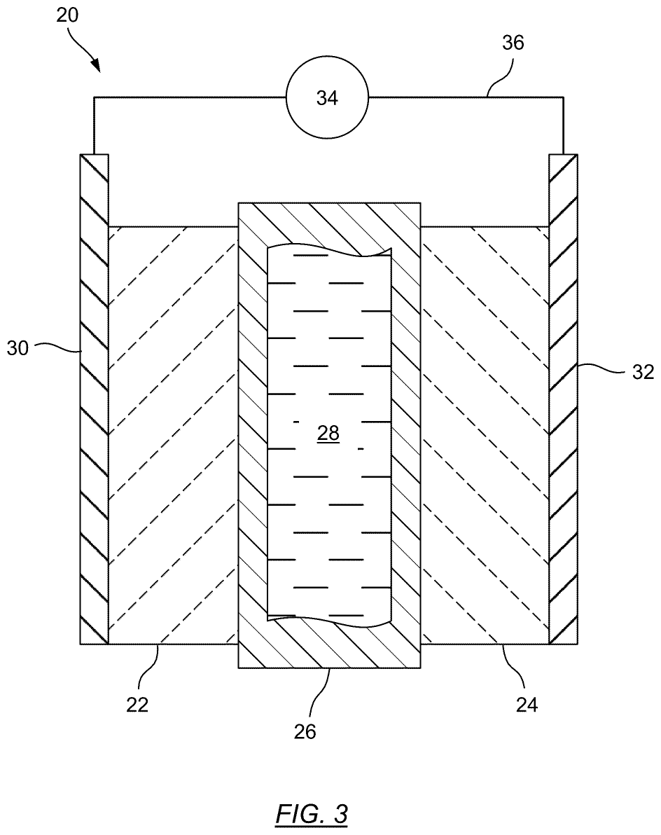

FIG. 3 depicts an electrochemical cell or battery 20 that cycles lithium ions. The battery 20 can generate an electric current during discharge, which may be used to supply power to a load device (e.g., the electric motor 4), and can be charged by being connected to a power source. Like the batteries 10 depicted in FIGS. 1 and 2, in aspects, the battery 20 may be used to supply power to an electric motor 4 of an automotive vehicle 2. Additionally or alternatively, the battery 20 may be used in other transportation applications (e.g., motorcycles, boats, tractors, buses, motorcycles, mobile homes, campers, tanks, and aircraft), and may be used to provide electricity to stationary and/or portable electronic equipment, components, and devices used in a wide variety of other industries and applications, including industrial, residential, and commercial buildings, consumer products, industrial equipment and machinery, agricultural or farm equipment, and heavy machinery, by way of nonlimiting example.

The battery 20 comprises a negative electrode 22, a positive electrode 24, a separator 26, and an electrolyte 28 that provides a medium for conduction of lithium ions between the negative electrode 22 and the positive electrode 24. The negative electrode 22 is disposed on a major surface of a negative electrode current collector 30 and the positive electrode 24 is disposed on a major surface of a positive electrode current collector 32. In practice, the negative electrode current collector 30 and the positive electrode current collector 32 are electrically coupled to a power source or load 34 (e.g., the electric motor 4) via an external circuit 36. The negative electrode 22 and the positive electrode 24 are formulated such that, when the battery 20 is at least partially charged, an electrochemical potential difference is established between the negative electrode 22 and the positive electrode 24. During discharge of the battery 20, the electrochemical potential established between the negative electrode 22 and the positive electrode 24 drives spontaneous reduction and oxidation (redox) reactions within the battery 20 and the release of lithium ions and electrons from the negative electrode 22. The released lithium ions travel from the negative electrode 22 to the positive electrode 24 through the separator 26 and the electrolyte 28, while the electrons travel from the negative electrode 22 to the positive electrode 24 via the external circuit 36, which generates an electric current. After the negative electrode 22 has been partially or fully depleted of lithium, the battery 20 may be charged by connecting the negative electrode 22 and the positive electrode 24 to the power source 34, which drives nonspontaneous redox reactions within the battery 20 and the release of the lithium ions and the electrons from the positive electrode 24. The repeated discharge and charge of the battery 20 may be referred to herein as “cycling,” with a full charge event followed by a full discharge event being considered a full cycle.

The positive electrode 24 is formulated to store and release lithium ions during discharge and charge of the battery 20. The positive electrode 24 may be in the form of a continuous porous layer disposed on the major surface of the positive electrode current collector 32. The positive electrode 24 comprises an electrochemically active (electroactive) material (electroactive positive electrode material), a polymer binder, and optionally an electrically conductive material. In aspects, the electroactive material of the positive electrode 24 may be a particulate material and particles of the electroactive material of the positive electrode 24 may be intermingled with the polymer binder and the optional electrically conductive material.

The electroactive material of the positive electrode 24 can store and release lithium ions by undergoing a reversible redox reaction with lithium at a higher electrochemical potential than the electrochemically active material of the negative electrode 22 such that an electrochemical potential difference exists between the negative electrode 22 and the positive electrode 24. The electroactive material of the positive electrode 24 may comprise an intercalation host material that can undergo the reversible insertion or intercalation of lithium ions. In such a case, the electroactive material of the positive electrode 24 may comprise a lithium transition metal oxide. For example, the electroactive material of the positive electrode 24 may comprise a layered lithium transition metal oxide represented by the formula LiMeO₂ and/or Li₂MeO₃, a layered lithium-rich transition metal oxide represented by the formula Li₁₊ₓMe₁₋ₓO₂ (where 0<x≤0.33), an olivine-type lithium transition metal oxide represented by the formula LiMePO₄, a monoclinic-type lithium transition metal oxide represented by the formula Li₃Me₂(PO₄)₃, a spinel-type lithium transition metal oxide represented by the formula LiMe₂O₄, a tavorite represented by one or both of the following formulas LiMeSO₄F or LiMePO₄F, or a combination thereof, where Me is a transition metal (e.g., Co, Ni, Mn, Fe, Al, V, or a combination thereof). The electroactive material of the positive electrode 24 may constitute, by weight, greater than or equal to 70%, optionally greater than or equal to 80%, or optionally greater than or equal to 90% and less than or equal to 98%, or optionally less than or equal to 95% of the positive electrode 24.

In aspects, the electroactive material of the positive electrode 24 may comprise a layered nickel-rich lithium transition metal oxide represented by the formula LiNi₁₋ₓMeₓO₂, where x is greater than or equal to 0, or optionally greater than or equal to 0.1, and less than 0.4, optionally less than or equal to 0.3, optionally less than or equal to 0.2, or optionally less than or equal to 0.1, and where Me comprises a transition metal. In aspects, Me may comprise manganese (Mn), cobalt (Co), aluminum (Al), or a combination thereof.

In aspects, the electroactive material of the positive electrode 24 may comprise a layered lithium-rich manganese-based oxide (LMR) represented by the formula Li₁₊ₓMe₁₋ₓO₂, where x is greater than 0 and less than or equal to 0.33, Me comprises a transition metal, and Me comprises greater than or equal to 50 atomic percent Mn.

The polymer binder is electrochemically inactive and may be included in the positive electrode 24 to provide the positive electrode 24 with structural integrity and/or to help the positive electrode 24 adhere to the major surface of the positive electrode current collector 32. Examples of polymer binders include polyvinylidene fluoride (PVdF), polytetrafluoroethylene (PTFE), ethylene propylene diene monomer (EPDM) rubber, styrene butadiene rubber (SBR), carboxymethyl cellulose (CMC), nitrile butadiene rubber (NBR), styrene-butadiene rubber (SBR), styrene ethylene butylene styrene copolymer (SEBS), polyacrylates, alginates, polyacrylic acid, and combinations thereof. The polymer binder may constitute, by weight, greater than or equal to 1%, or optionally greater than or equal to 5%, and less than or equal to 10% of the positive electrode 24.

The optional electrically conductive material is electrochemically inactive and may be included in the positive electrode 24 to provide the positive electrode 24 with sufficient electrical conductivity to support the percolation of electrons therethrough. Examples of electrically conductive materials include carbon-based materials, metals (e.g., nickel), and/or electrically conductive polymers. Examples of electrically conductive carbon-based materials include carbon black (CB) (e.g., acetylene black), graphite, graphene (e.g., graphene nanoplatelets, GNP), graphene oxide, carbon nanotubes (CNT), and/or carbon fibers (e.g., carbon nanofibers). Examples of electrically conductive polymers include polyaniline, polythiophene, polyacetylene, and/or polypyrrole. When included in the positive electrode 24, the optional electrically conductive material may constitute, by weight, greater than 0%, optionally greater than or equal to 1%, or optionally greater than or equal to 5% and less than or equal to 10% of the positive electrode 24.

The negative electrode 22 is formulated to store and release lithium ions to facilitate charge and discharge, respectively, of the battery 20. The negative electrode 22 may be in the form of a continuous layer of material disposed on a major surface of the negative electrode current collector 30. The negative electrode 22 comprises an electrochemically active (electroactive) material (electroactive negative electrode material) that can store and release lithium ions by undergoing a reversible redox reaction with lithium during charge and discharge of the battery 20. Examples of electroactive negative electrode materials include lithium, lithium-based materials (e.g., alloys of lithium and silicon, aluminum, indium, and/or tin), carbon-based materials (e.g., graphite, activated carbon, carbon black, hard carbon, soft carbon, and/or graphene), silicon, silicon-based materials (e.g., alloys of silicon and lithium, tin, iron, aluminum, and/or cobalt), silicon oxide, silicon oxide-based materials (e.g., lithiated silicon oxide), tin oxide, aluminum, indium, zinc, germanium, titanium oxide, lithium titanate, and combinations thereof. The electroactive material of the negative electrode 22 may constitute, by weight, greater than or equal to 70%, optionally greater than or equal to 80%, or optionally greater than or equal to 90% and less than or equal to 98%, or optionally less than or equal to 95% of the negative electrode 22. The same polymer binders and/or electrically conductive materials disclosed above with respect to the positive electrode 24 may be used in the negative electrode 22 in substantially the same amounts.

The electrolyte 28 is ionically conductive and provides a medium for the conduction of lithium ions between the negative electrode 22 and the positive electrode 24. The electrolyte 28 is formulated to help improve the thermal stability of the battery 20, particularly in embodiments where the electroactive material of the positive electrode 24 comprises a layered nickel-rich lithium transition metal oxide. The electrolyte 28 comprises an organic solvent, a lithium salt in the organic solvent, and optionally an additive.

The organic solvent comprises a primary solvent and optionally a secondary solvent. The organic solvent may comprise, by weight, greater than or equal to 60%, optionally greater than or equal to 70%, optionally greater than or equal to 80%, or optionally greater than or equal to 90%, and less than or equal to 95%, optionally less than or equal to 93%, or optionally less than or equal to 90% of the electrolyte 28.

The primary solvent is formulated to provide the electrolyte 28 with chemical stability, good ionic conductivity, and the ability to assist in formation of a cathode electrolyte interphase (CEI) on surfaces of the electroactive material of the positive electrode 24 during cycling of the battery 20. The primary solvent comprises a fluorinated or non-fluorinated, saturated, acyclic alkyl alkanoate, ketone, nitrile, or a combination thereof. The primary solvent may comprise, by weight, greater than or equal to 70%, optionally greater than or equal to 80%, optionally greater than or equal to 90%, optionally greater than or equal to 95%, optionally greater than or equal to 97%, optionally greater than or equal to 99%, or optionally greater than or equal to 99.9%, and less than or equal to 100% of the organic solvent.

In aspects where the primary solvent comprises an alkyl alkanoate, the alkyl alkanoate may have the formula R¹—COO—R², where R¹ is H or an alkyl or fluoroalkyl having 1 to 3 carbon atoms (i.e., a C₁-C₃ alkyl or a C₁-C₃ fluoroalkyl), and R² is an alkyl or fluoroalkyl having 1 to 4 carbon atoms (i.e., a C₁-C₄ alkyl or a C₁-C₄ fluoroalkyl). The term “alkyl” means a linear or branched chain hydrocarbon group containing no unsaturation. The term “fluoroalkyl” means an alkyl wherein at least one hydrogen is replaced by fluorine. Examples of alkyl alkanoates having the formula R¹—COO—R₂ include 2,2,2-trifluoroethyl acetate (FEA), ethyl acetate (EA), n-propyl acetate (nPA), i-propyl acetate (iPA), n-butyl acetate (nBA), i-butyl acetate (iBA), methyl propionate (MP), methyl butyrate (MB), methyl formate (MF), ethyl formate (EF), n-propyl formate (nPF), i-propyl formate (iPF), n-butyl formate (nBF), and i-butyl formate (iBF). In aspects, the primary solvent may comprise FEA.

In aspects where the primary solvent comprises a ketone, the ketone may have the formula R³—C(═O)—R⁴, where R³ and R⁴ are each individually an alkyl or fluoroalkyl having 1 to 2 carbon atoms (i.e., a C₁-C₂ alkyl or a C₁-C₂ fluoroalkyl). Examples of ketones having the formula R³—C(═O)—R⁴ include acetone and 2-butanone.

In aspects where the primary solvent comprises a nitrile, the nitrile may have the formula R⁵—C≡N, where R⁵ is a C₁-C₃ alkyl or a C₁-C₃ fluoroalkyl. Examples of nitriles having formula R⁵—C≡N include acetonitrile (ACN), propionitrile (PN), n-butyronitrile (nBN), and i-butyronitrile (iBN).

The optional secondary solvent may be formulated to provide the electrolyte 28 with good ionic conductivity, for example, by providing the electrolyte 28 with a relatively high dielectric constant and/or with a relatively low viscosity, as compared to that of the primary solvent. When present in the organic solvent, the secondary solvent may comprise, by weight, greater than 0% and less than or equal to 30% of the organic solvent.

The optional secondary solvent may comprise a linear organic carbonate, a cyclic organic carbonate, or a combination thereof. Examples of linear organic carbonates include dimethyl carbonate (DMC), ethyl methyl carbonate (EMC), and diethyl carbonate (DEC). When present in the electrolyte 28, the linear organic carbonate may comprise, by weight, greater than 0% and less than or equal to 30%, optionally less than or equal to 20%, optionally less than or equal to 10%, optionally less than or equal to 5%, optionally less than or equal to 3%, optionally less than or equal to 1%, or optionally less than or equal to 0.1% of the organic solvent. Examples of cyclic organic carbonates include ethylene carbonate (EC), propylene carbonate (PC), and fluoroethylene carbonate (FEC). When present in the electrolyte 28, the cyclic organic carbonate may comprise, by weight, greater than 0% and less than or equal to 15%, optionally less than or equal to 10%, optionally less than or equal to 5%, optionally less than or equal to 3%, optionally less than or equal to 1%, or optionally less than or equal to 0.1% of the organic solvent. In aspects, the electrolyte 28 may be substantially free of organic carbonates. In aspects, the electrolyte 28 may be substantially free of cyclic organic carbonates. In aspects, the electrolyte 28 may be substantially free of ethylene carbonate (EC).

The optional additive may be formulated to participate in formation of a solid electrolyte interphase (SEI and/or CEI) on surfaces of the electroactive material of the negative electrode 22 and/or the positive electrode 24. When present in the electrolyte 28, the additive may comprise, by weight, greater than 0% and less than or equal to 10% of the electrolyte 28. In aspects, the additive may comprise a first chemical compound formulated to participate in formation of a CEI on surfaces of the electroactive material of the positive electrode 24 and/or a second chemical compound formulated to participate in formation of an SEI on surfaces of the electroactive material of the negative electrode 22.

Examples of chemical compounds that may be included in the electrolyte 28 as additives to help participate in formation of a CEI on surfaces of the electroactive material of the positive electrode 24 include succinic anhydride (SA), trimethoxymethylsilane (TMSi), and tris(trimethylsilyl)phosphite (TMSPi). When present in the electrolyte 28, the first chemical compound may comprise, by weight, greater than or equal to 0.1%, or optionally greater than or equal to 0.5%, and less than or equal to 5%, optionally less than or equal to 3%, or optionally less than or equal 1% of the electrolyte 28. In aspects, the electrolyte 28 may comprise, by weight, about 1% TMSi and about 0.5% SA.

Examples of chemical compounds that may be included in the electrolyte 28 as additives to help participate in formation of an SEI on surfaces of the electroactive material of the negative electrode 22 include vinyl carbonate (VC), fluoroethylene carbonate (FEC), and 1,3,2-dioxathiolane 2,2-dioxide (DTD). VC may be particularly beneficial in forming an SEI on surfaces of the electroactive material of the negative electrode 22 in embodiments where the electroactive material of the negative electrode 22 comprises graphite and/or silicon. FEC may be particularly beneficial in forming an SEI on surfaces of the electroactive material of the negative electrode 22 in embodiments where the electroactive material of the negative electrode 22 comprises silicon. When present in the electrolyte 28, the second chemical compound may comprise, by weight, greater than or equal to 0.1%, optionally greater than or equal to 0.5%, optionally greater than or equal to 2%, or optionally greater than or equal to 5%, and less than or equal to 15%, optionally less than or equal to 10%, or optionally less than or equal 5%, of the electrolyte 28. In aspects, the electrolyte 28 may comprise, by weight, greater than or equal to 0.5% and less than or equal to 2% VC. In aspects, the electrolyte 28 may comprise, by weight, greater than or equal to 5% and less than or equal to 15% FEC.

The lithium salt is soluble in the organic solvent and provides a passage for lithium ions through the electrolyte 28. Examples of lithium salts include lithium hexafluorophosphate (LiPF₆), lithium bis(fluorosulfonyl)imide (LiN(FSO₂)₂) (LiFSI), lithium bis(trifluoromethanesulfonyl)imide (LiN(CF₃SO₂)₂) (LiTFSI), lithium tetrafluoroborate (LiBF₄), lithium bis(oxalato)borate (LiB(C₂O₄)₂) (LiBOB), and lithium difluoro(oxalato)borate (LiBF₂(C₂O₄)) (LiDFOB). In aspects, the lithium salt may comprise LiPF₆. The lithium salt may be dissolved in the organic solvent and present in the electrolyte 28 at a concentration of greater than or equal to 0.5 Molar, or optionally greater than or equal to 0.8 Molar, and less than or equal to 4 Molar, optionally less than or equal to 1.6 Molar, or optionally less than or equal to 1.2 Molar. This may mean that the lithium salt comprises, by weight, greater than or equal to 8%, optionally greater than or equal to 10%, or optionally greater than or equal to 15%, and less than or equal to 30%, or optionally less than or equal to 20% of the electrolyte 28.

In aspects, the lithium salt may comprise a primary lithium salt and a secondary lithium salt. In such case, the primary lithium salt may comprise LiPF₆ and may be present in the electrolyte 28 at a concentration of greater than or equal to 0.6 Molar and less than or equal to 1 Molar. The secondary lithium salt may comprise LiFSI and/or LiTFSI and may be present in the electrolyte 28 at a concentration of greater than or equal to 0.2 Molar and less than or equal to 0.6 Molar.

The separator 26 physically separates and electrically isolates the negative electrode 22 and the positive electrode 24 from each other while permitting lithium ions to pass therethrough. The separator 26 has an open microporous structure and may comprise an organic and/or inorganic material. For example, the separator 26 may comprise a polymer. Examples of polymers for the separator 26 include polyolefins (e.g., polyethylene, PE, and/or polypropylene, PP), polyamide (PA), poly(tetrafluoroethylene) (PTFE), polyvinylidene fluoride (PVDF), poly (vinyl chloride) (PVC), and combinations thereof. In one form, the separator 26 may comprise a laminate of polymers, e.g., a laminate of PE and PP. In aspects, the separator 26 may comprise a ceramic coating (not shown) disposed on one or both sides thereof. In such case, the ceramic coating may comprise particles of alumina (Al₂O₃) and/or silica (SiO₂).

The negative electrode current collector 30 and the positive electrode current collector 32 are electrochemically active and electrically conductive. The negative electrode current collector 30 and the positive electrode current collector 32 are formulated to provide an electrical connection between the external circuit 36 and the negative electrode 22 and the positive electrode 24, respectively. In aspects, the negative electrode current collector 30 and the positive electrode current collector 32 may be in the form of nonporous metal foils, perforated metal foils, porous metal meshes, or a combination thereof. The negative electrode current collector 30 and the positive electrode current collector 32 may be made of metal or other appropriate electrically conductive material (e.g., carbon). In aspects where the negative electrode current collector 30 and/or the positive electrode current collector 32 are made of metal, the metal may be a substantially pure elemental metal or an alloy of an elemental metal and one or more other metal or nonmetal elements (referred to as “alloying” elements). In some examples, the negative electrode current collector 30 may be made of copper, nickel, or stainless steel, and the positive electrode current collector 32 may be made of aluminum.

### EXPERIMENTAL

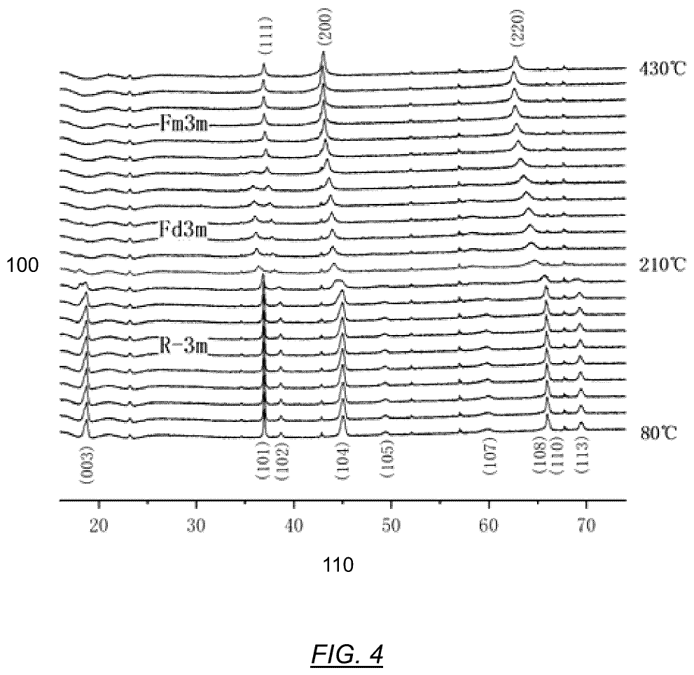

The thermal stability of a layered nickel-rich oxide having the formula LiNi_{1-x-y-z}CoₓMn_{y}Al_{z}O₂ (NCMA), where 0<(x+y+z)≤0.4, was evaluated using in operando X-ray diffraction analysis (XRD) to identify changes in the crystal structure of the Ni-rich oxide as the Ni-rich oxide was heated from about ambient temperature (e.g., 25° C.) to about 430° C. FIG. 4 is a plot of Intensity (arbitrary units) 100 vs. 2θ (degree) 110 depicting XRD spectra of the Ni-rich oxide at various temperatures. As shown in FIG. 4, the Ni-rich oxide undergoes a change in crystal structure when heated at temperatures greater than or equal to 210° C.

Full coin cells including electrolytes in accordance with embodiments of the present disclosure were assembled and evaluated using galvanostatic charge and discharge protocols. All cells included a positive electrode comprising an electroactive material consisting of a layered nickel-rich oxide having the formula LiNi_{1-x-y-z}CoₓMn_{y}Al_{z}O₂ (NCMA), where 0<(x+y+z)≤0.4. The positive electrodes had a diameter of about 3 millimeters (mm) and a loading of about 4 milliampere-hours per square centimeter (mAh/cm²). All cells included a negative electrode comprising an electroactive material consisting of a mixture of 30 wt % lithiated silicon oxide and 70 wt % graphite. The negative electrodes had a loading of about 4.4 mAh/cm². All cells included 120 microliters (μL) of an exemplary electrolyte comprising 1 Molar LiPF₆ dissolved in 1 Liter 2,2,2-trifluoroethyl acetate (FEA), with 2 wt % FEC and 1 wt % VC. The LiPF₆ comprised, by weight, about 9.1% of the exemplary electrolyte and the FEA comprised, by weight, about 87.9% of the exemplary electrolyte.

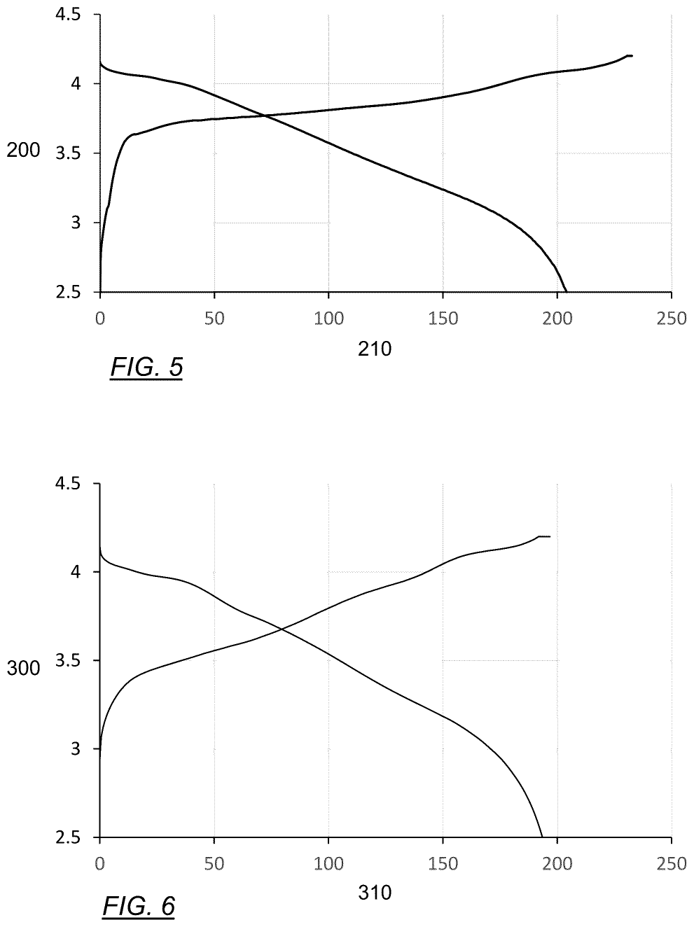

The cells were galvanostatically charged and discharged at 25° C. During formation, the cells were charged at a C/20 rate to 4.2 V and then subsequently discharged to 2.5 V. FIG. 5 is a plot of Voltage (V) 200 vs. Specific Capacity (milliampere-hours per gram, mAh/g) 210 depicting the charge and discharge curves of one of the cells during formation. After formation, the cells had an average specific charge capacity of 231 mAh/g, an average specific discharge capacity of 202.5 mAh/g, and an average coulombic efficiency of 87.6%.

After formation, a constant current and constant voltage (CCCV) protocol was used to charge and discharge the cells at different rates. FIG. 6 is a plot of Voltage (V) 300 vs. Specific Capacity (mAh/g) 310 depicting the charge and discharge curves of one of the cells charged and discharged at a C/3 rate. The Capacity Retention of cells charged and discharged at a C/3 rate after 100 cycles was about 95%.

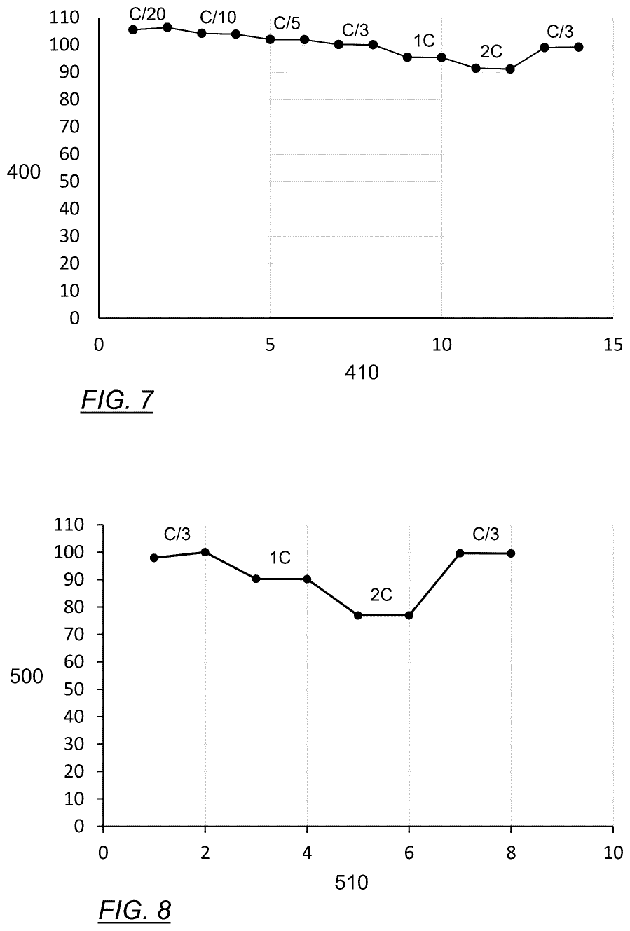

FIG. 7 is a plot of Discharge Capacity Retention (%) 400 vs. Cycle Number 410 for one of the cells discharged at different rates. The Discharge Capacity Retention values shown in FIG. 7 were calculated as a percentage of the Discharge Capacity of the cell at a specific discharge rate versus the Discharge Capacity of the cell at a C/3 discharge rate.

FIG. 8 is a plot of Capacity Retention (%) 500 vs. Cycle Number 510 for one of the cells charged at different rates. The Capacity Retention values shown in FIG. 8 were calculated as a percentage of the Capacity of the cell at a specific charge rate versus the Capacity of the cell at a C/3 charge rate.

After some of the cells were subjected to a full charge and discharge cycle, the positive electrodes were removed therefrom and analyzed using differential scanning calorimetry (DSC) to evaluate the thermal stability of the positive electrodes when heated in the absence of and in the presence of different electrolyte formulations. After the positive electrodes were removed from the cells, the positive electrodes were washed with dimethyl carbonate (DMC) to remove residual salts, dried at 80° C. to remove the DMC therefrom, placed in an aluminum boat, sealed, and heated in a DSC machine at a heating rate of 5° C. per minute to a temperature of 300° C. For comparison, 40 wt % of a baseline electrolyte or an exemplary electrolyte formulated in accordance with embodiments of the present disclosure was added to the aluminum boat with some of the positive electrodes. The baseline electrolyte included 1 Molar LiPF₆ in 1 Liter of an organic solvent comprising a mixture of EC and EMC (volumetric ratio of EC:EMC=30:70), with addition of 2 wt % FEC and 1 wt % VC. The exemplary electrolyte included 1 Molar LiPF₆ dissolved in 1 Liter 2,2,2-trifluoroethyl acetate (FEA), with addition of 2 wt % FEC and 1 wt % VC.

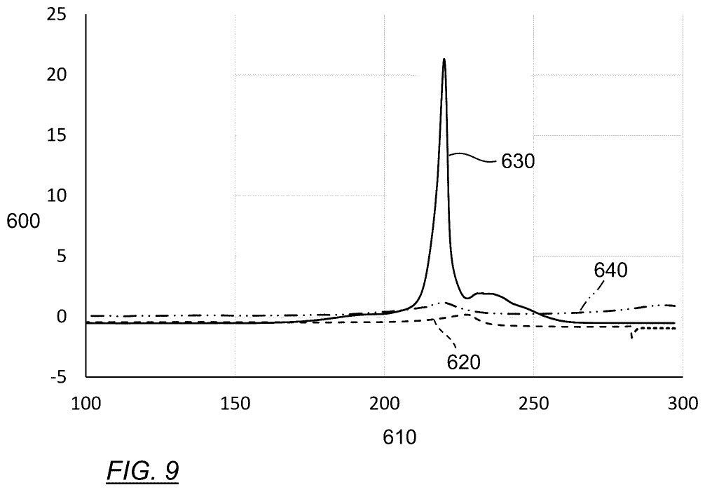

FIG. 9 is a plot of Heat Flow (Watts per gram, W/g) 600 vs. Temperature (° C.) 610 for a dry positive electrode (without electrolyte) 620, a positive electrode with 40 wt % of the baseline electrolyte 630, and a positive electrode with 40 wt % of the exemplary electrolyte 640. As shown, a small exothermic peak is observed at about 220° C. when the dry positive electrode 620 and the positive electrode with 40 wt % of the exemplary electrolyte 640 are heated, indicating that the Ni-rich oxide in the positive electrode undergoes a phase temperature when heated at such temperatures with the concomitant release of oxygen. However, unlike the positive electrode with 40 wt % of the baseline electrolyte 630, the dry positive electrode 620 and the positive electrode with 40 wt % of the exemplary electrolyte 640 did not undergo an acute exothermic reaction.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

The terminology used herein is for the purpose of describing example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended terms “comprises,” “comprising,” “including,” and “having,” are to be understood as non-restrictive terms used to describe and claim various embodiments set forth herein, in certain aspects, the terms may alternatively be understood to instead be a more limiting and restrictive term, such as “consisting of” or “consisting essentially of.” Thus, for any given embodiment reciting compositions, materials, components, elements, ingredients, features, integers, operations, and/or process steps, the present disclosure also specifically includes embodiments consisting of, or consisting essentially of, such recited compositions, materials, components, elements, ingredients, features, integers, operations, and/or process steps. In the case of “consisting of,” the alternative embodiment excludes any additional compositions, materials, components, elements, ingredients, features, integers, operations, and/or process steps, while in the case of “consisting essentially of,” any additional compositions, materials, components, elements, ingredients, features, integers, operations, and/or process steps that materially affect the basic and novel characteristics are excluded from such an embodiment, but any compositions, materials, components, elements, ingredients, features, integers, operations, and/or process steps that do not materially affect the basic and novel characteristics can be included in the embodiment.

As used herein, the phrase at least one of A, B, and C should be construed to mean a logical (A OR B OR C), using a non-exclusive logical OR, and should not be construed to mean “at least one of A, at least one of B, and at least one of C.”

As used herein, the terms “composition” and “material” are used interchangeably to refer broadly to a substance containing at least the preferred chemical constituents, elements, or compounds, but which may also comprise additional elements, compounds, or substances, including trace amounts of impurities, unless otherwise indicated. An “X-based” composition or material broadly refers to compositions or materials in which “X” is the single largest constituent of the composition or material on a weight percentage (%) basis. This may include compositions or materials having, by weight, greater than 50% X, as well as those having, by weight, less than 50% X, so long as X is the single largest constituent of the composition or material based upon its overall weight. When a composition or material is referred to as being “substantially free” of a substance, the composition or material may comprise, by weight, less than 5%, optionally less than 3%, optionally less than 1%, or optionally less than 0.1% of the substance.

What is claimed is:

1. A battery that cycles lithium ions, the battery comprising:
a positive electrode comprising an electroactive material comprising a layered nickel-rich lithium transitional metal oxide; and
an electrolyte infiltrating the positive electrode, the electrolyte comprising:
an organic solvent comprising greater than or equal to 70 weight percent of a primary solvent comprising an alkyl alkanoate, ketone, nitrile, or a combination thereof, and
a lithium salt in the organic solvent.

2. The battery of claim 1, wherein the primary solvent comprises an alkyl alkanoate having the formula R¹—COO—R²,
wherein R¹ is H, a C₁-C₃ alkyl, or a C₁-C₃ fluoroalkyl, and
wherein R² is a C₁-C₄ alkyl or a C₁-C₄ fluoroalkyl.

3. The battery of claim 2, wherein the primary solvent comprises at least one alkyl alkanoate selected from the group consisting of 2,2,2-trifluoroethyl acetate (FEA), ethyl acetate (EA), n-propyl acetate (nPA), i-propyl acetate (iPA), n-butyl acetate (nBA), i-butyl acetate (iBA), methyl propionate (MP), methyl butyrate (MB), methyl formate (MF), ethyl formate (EF), n-propyl formate (nPF), i-propyl formate (iPF), n-butyl formate (nBF), and i-butyl formate (iBF).

4. The battery of claim 1, wherein the primary solvent comprises a ketone having the formula R³—C(═O)—R⁴,
wherein R³ and R⁴ are each individually a C₁-C₂ alkyl or a C₁-C₂ fluoroalkyl.

5. The battery of claim 4, wherein the primary solvent comprises at least one ketone selected from the group consisting of acetone and 2-butanone.

6. The battery of claim 1, wherein the primary solvent comprises a nitrile having the formula R⁵—C≡N,
wherein R⁵ is a C₁-C₃ alkyl or a C₁-C₃ fluoroalkyl.

7. The battery of claim 6, wherein the primary solvent comprises at least one nitrile selected from the group consisting of acetonitrile (ACN), propionitrile (PN), n-butyronitrile (nBN), and i-butyronitrile (iBN).

8. The battery of claim 1, wherein the organic solvent comprises greater than 0 weight percent and less than 30 weight percent of at least one linear organic carbonate selected from the group consisting of dimethyl carbonate (DMC), ethyl methyl carbonate (EMC), and diethyl carbonate (DEC).

9. The battery of claim 1, wherein the organic solvent comprises greater than 0 weight percent and less than 15 weight percent of at least one cyclic organic carbonate selected from the group consisting of ethylene carbonate (EC), propylene carbonate (PC), and fluoroethylene carbonate (FEC).

10. The battery of claim 1, wherein the electrolyte is substantially free of cyclic organic carbonates.

11. The battery of claim 1, wherein the electrolyte comprises greater than or equal to 0.5 Molar and less than or equal to 4 Molar of at least one lithium salt selected from the group consisting of lithium hexafluorophosphate (LiPF₆), lithium bis(fluorosulfonyl)imide (LiFSI), lithium bis(trifluoromethanesulfonyl)imide (LiTFSI), lithium tetrafluoroborate (LiBF₄), lithium bis(oxalato)borate (LiBOB), and lithium difluoro(oxalato)borate (LiDFOB).

12. The battery of claim 1, wherein the electrolyte comprises greater than or equal to 0.6 Molar and less than or equal to 1 Molar of a primary lithium salt consisting of LiPF₆, and wherein the electrolyte comprises greater than or equal to 0.2 Molar and less than or equal to 0.6 Molar of at least one secondary lithium salt selected from the group consisting of LiFSI and LiTFSI.

13. The battery of claim 1, wherein the electrolyte further comprises greater than 0 weight percent and less than or equal to 10 weight percent of at least one additive selected from the group consisting of succinic anhydride (SA), trimethoxymethylsilane (TMSi), and tris(trimethylsilyl) phosphite (TMSPi).

14. The battery of claim 1, wherein the electroactive material of the positive electrode comprises a layered nickel-rich lithium transition metal oxide represented by the formula LiNi₁₋ₓMeₓO₂, wherein 0≤x<0.4, and wherein Me comprises manganese (Mn), cobalt (Co), aluminum (Al), or a combination thereof.

15. A battery that cycles lithium ions, the battery comprising:
a negative electrode comprising an electroactive negative electrode material comprising silicon, silicon oxide, lithiated silicon oxide, and/or graphite;
a positive electrode spaced apart from the negative electrode and comprising an electroactive positive electrode material comprising a layered nickel-rich lithium transition metal oxide represented by the formula LiNi₁₋ₓMeₓO₂, wherein 0≤x<0.4, and wherein Me comprises manganese (Mn), cobalt (Co), aluminum (Al), or a combination thereof; and
an electrolyte infiltrating the negative electrode and the positive electrode, the electrolyte providing a medium for the conduction of lithium ions between the negative electrode and the positive electrode, the electrolyte comprising:
greater than or equal to 60 weight percent and less than or equal to 93 weight percent of an organic solvent, the organic solvent comprising greater than or equal to 70 weight percent of a primary solvent comprising at least one of:
an alkyl alkanoate having the formula R¹—COO—R², wherein R¹ is H, a C₁-C₃ alkyl, or a C₁-C₃ fluoroalkyl, and wherein R² is a C₁-C₄ alkyl or a C₁-C₄ fluoroalkyl,
a ketone having the formula R³—C(═O)—R⁴, wherein R³ and R⁴ are each individually a C₁-C₂ alkyl or a C₁-C₂ fluoroalkyl, or
a nitrile having the formula R⁵—C≡N, wherein R⁵ is a C₁-C₃ alkyl or a C₁-C₃ fluoroalkyl, and
a lithium salt in the organic solvent.

16. The battery of claim 15, wherein the primary solvent comprises at least one alkyl alkanoate selected from the group consisting of 2,2,2-trifluoroethyl acetate (FEA), ethyl acetate (EA), n-propyl acetate (nPA), i-propyl acetate (iPA), n-butyl acetate (nBA), i-butyl acetate (iBA), methyl propionate (MP), methyl butyrate (MB), methyl formate (MF), ethyl formate (EF), n-propyl formate (nPF), i-propyl formate (iPF), n-butyl formate (nBF), and i-butyl formate (iBF).

17. The battery of claim 15, wherein the primary solvent consists of 2,2,2-trifluoroethyl acetate (FEA).

18. The battery of claim 15, wherein the primary solvent comprises at least one ketone selected from the group consisting of acetone and 2-butanone.

19. The battery of claim 15, wherein the primary solvent comprises at least one nitrile selected from the group consisting of acetonitrile (ACN), propionitrile (PN), n-butyronitrile (nBN), and i-butyronitrile (iBN).

20. The battery of claim 15, wherein the organic solvent comprises greater than 0 weight percent and less than 30 weight percent of at least one linear organic carbonate selected from the group consisting of dimethyl carbonate (DMC), ethyl methyl carbonate (EMC), and diethyl carbonate (DEC), and wherein the organic solvent comprises greater than 0 weight percent and less than 15 weight percent of at least one cyclic organic carbonate selected from the group consisting of ethylene carbonate (EC), propylene carbonate (PC), and fluoroethylene carbonate (FEC).
